(19) United States
(12) Patent Application Publication
(10) Pub. No.: US 2024/0095708 A1
(43) Pub. Date: Mar. 21, 2024

(54) PAYMENT DEVICE

(71) Applicant: Toshiba Tec Kabushiki Kaisha, Tokyo (JP)

(72) Inventors: Naotake HIRAMATSU, Ota Tokyo (JP); Tsuyoshi GOTANDA, Ota Tokyo (JP)

(21) Appl. No.: 18/354,606

(22) Filed: Jul. 18, 2023

(30) Foreign Application Priority Data
Sep. 16, 2022 (JP) 2022-148110

(51) Int. Cl. G06Q 20/20

(52) U.S. Cl. CPC G06Q 20/206

(57) ABSTRACT

A payment device is to be operated by a customer to make payment for a transaction. Transaction data for the transaction is generated by a registration device operated by a store clerk. The payment device includes a sensor configured to detect motion when enabled, and a processor configured to enable the sensor upon receipt of a notification that the transaction data has been generated, in response to the motion being detected by the sensor while the payment is pending, acquire the transaction data generated by the registration device, and perform a payment process using the acquired transaction data.

### CROSS-REFERENCE TO RELATED APPLICATION(S)

This application is based upon and claims the benefit of priority from Japanese Patent Application No. 2022-148110, filed Sep. 16, 2022, the entire contents of which are incorporated herein by reference.

### FIELD

Embodiments described herein relate generally to a payment device, a point of sale (POS) system, and a method for performing a payment process using a payment device.

### BACKGROUND

In the retail industry, there is a checkout method in which an item registration operation and a payment operation are performed by different devices, e.g., a registration device and a payment device. Such a checkout method includes a semi-self-service method in which a store clerk performs the item registration operation and a customer performs the payment operation, a method of using a mobile registration terminal attached to a shopping cart and having the item registration function, a method of performing the item registration using a mobile terminal held by a customer or provided by a store, and the like. In such a checkout method, the item registration operation is performed by a store clerk or a customer, and the payment operation is performed by a customer.

In the semi-self-service method, the store clerk uses the registration device and performs not only the item registration operation but an operation for designating one of the payment devices for the customer to perform the payment operation after the item registration operation. However, it is cumbersome for the store clerk to perform such a designation operation after visually checking which of the payment devices is available.

### SUMMARY OF THE INVENTION

Embodiments of this disclosure provide a technique for reducing the workload of the operator of an item registration device.

In one embodiment, a payment device is to be operated by a customer to make payment for a transaction. Transaction data for the transaction is generated by a registration device operated by a store clerk. The payment device includes a sensor configured to detect motion when enabled, and a processor configured to enable the sensor upon receipt of a notification that the transaction data has been generated, in response to the motion being detected by the sensor while the payment is pending, acquire the transaction data generated by the registration device, and perform a payment process using the acquired transaction data.

### BRIEF DESCRIPTION OF THE DRAWINGS

FIG. 1 is a block diagram of a data processing system according to an embodiment.

FIG. 2 depicts an example of a layout of a store to which the data processing system is applicable.

FIG. 3 is a hardware block diagram of a server according to an embodiment.

FIG. 4 depicts a data structure of device relationship data stored in the server.

FIG. 5 is a hardware block diagram of a registration device according to an embodiment.

FIG. 6 is a hardware block diagram of a payment device according to an embodiment.

FIG. 7 depicts a first operation example of the data processing system.

FIG. 8 is a flowchart of processing performed by the registration device in the first operation example.

FIG. 9 is a flowchart of processing performed by the server in the first operation example.

FIG. 10 is a flowchart of processing related to acquiring payment data by the payment device in the first operation example.

FIG. 11 depicts a control operation for a sensor by the payment device in the first operation example.

FIG. 12 is a flowchart of processing related to the control operation for the sensor by the payment device in the first operation example.

FIG. 13 depicts a second operation example of the data processing system.

FIG. 14 is a flowchart of processing performed by the registration device in the second operation example.

### DETAILED DESCRIPTION

Hereinafter, embodiments will be described in detail with reference to the drawings. The present invention is not limited to the embodiments described below.

### Configuration Example

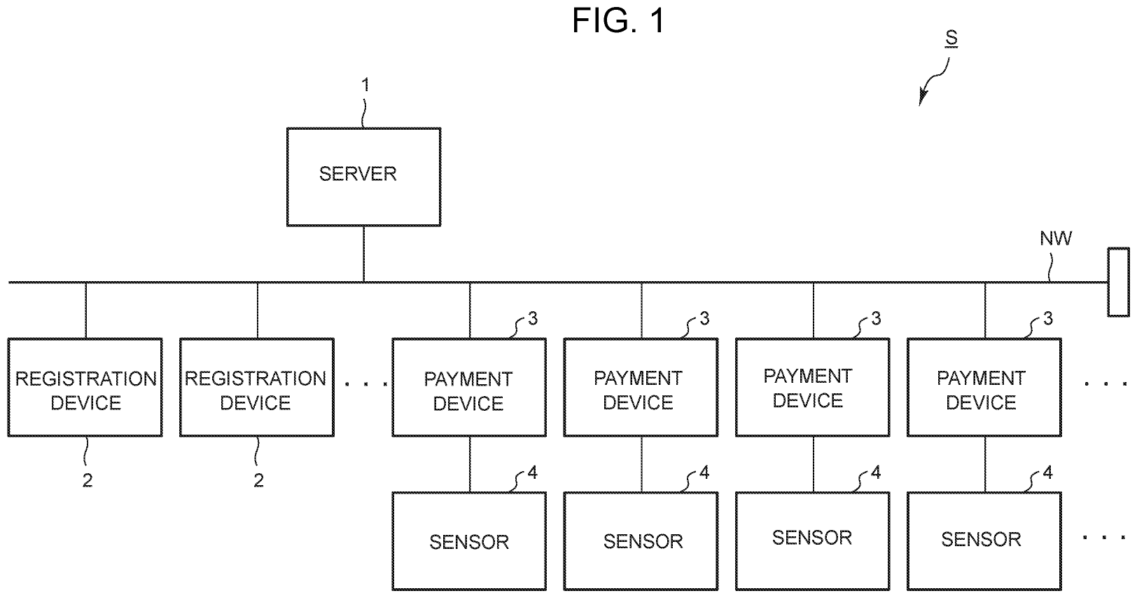

FIG. 1 is a block diagram illustrating a data processing system S according to an embodiment.

The data processing system S is a point of sale (POS) system that processes data in a store. In the data processing system S, a semi-self-service checkout method is used in which the item registration operation and the payment operation are performed by different devices.

The data processing system S includes a server 1, a plurality of registration devices 2, a plurality of payment devices 3, and a plurality of sensors 4. The server 1, the plurality of registering devices 2, and the plurality of payment devices 3 are communicably connected to each other via a network NW. For example, the network NW is a Local Area Network (LAN). The network NW may include a wireless network or may include a wired network.

Although the server 1 is illustrated in FIG. 1, the data processing system S may not include the server 1. Although a plurality of registration devices 2 are illustrated in FIG. 1, the data processing system S may include one registration device 2. The data processing system S is not limited to including all the above-described electronic devices. The data processing system S may refer to a system comprising at least one electronic device.

The server 1 is an information processing apparatus capable of processing data. The server 1 is an example of an information processing apparatus different from the registration device 2. A configuration example of the server 1 will be described later.

The registration device 2 is an electronic device capable of registering one or more items for each transaction between a customer and a store. The process of registering the item by the registration device 2 is also referred to as item registration. The item registered by the registration device 2 is also referred to as a registered item. The item that is not registered by the registration device 2 is referred to as an unregistered item. The registration device 2 generates the first payment data based on the item registration of one transaction. The first payment data may be any data that can be processed by the payment device 3 for completing a transaction, and the format of the first payment data is not limited. The first payment data is transaction data including item data for each registered item of one transaction, data of a payment amount of one transaction, and the like. The item data may include various data related to the item, such as an item name and price. The first payment data may include the transaction number identifying the transaction. A configuration example of the registration device 2 will be described later.

The payment device 3 is an electronic device capable of processing the payment of one transaction based on the item registration in the registration device 2. Each payment device 3 is connected to a corresponding one of the sensors 4. An example of the configuration of the payment device 3 will be described later.

The sensor 4 is a device that detects a customer present in the detection range of the sensor 4. The sensor 4 may be a contact type sensor or a non-contact type sensor. For example, the sensor 4 may be, but is not limited to, a camera, a human sensor, a Time of Flight (TOF) sensor, or the like. It is preferable that the recognition ranges of the sensors 4 do not overlap each other. Note that the sensor 4 may not be separate from the payment device 3. One payment device 3 may have one sensor 4.

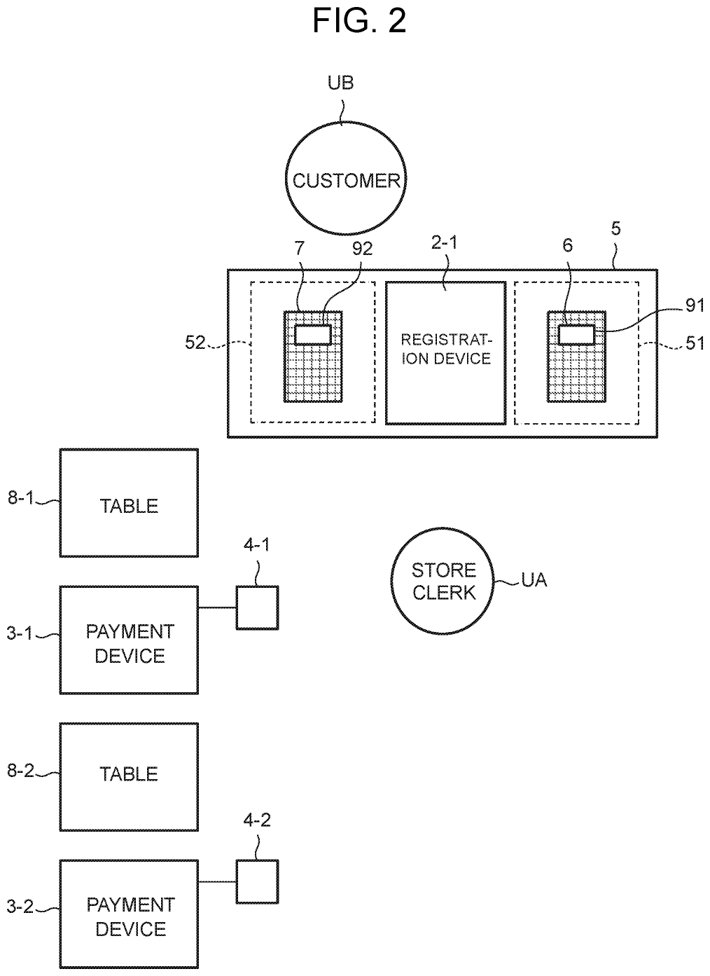

FIG. 2 depicts a layout of a store to which the data processing system S is applicable.

The registration device 2-1 is installed on a table 5. The registration device 2-1 is one of the plurality of registration devices 2. The registration device 2-1 is operated by a store clerk UA. The store clerk UA performs item registration of one transaction for a customer UB using the registration device 2-1. The store clerk UA is an exemplary user or operator of the registration device 2-1.

The table 5 includes an area 51 in which an unregistered item 91 of one transaction is placed. Although one unregistered item 91 is shown in FIG. 2, a plurality of unregistered items 91 may be placed in the area 51. The area 51 is also an area in which a basket 6 is placed. The basket 6 stores the unregistered items 91 of one transaction. Although one basket 6 is shown in FIG. 2, a plurality of baskets 6 may be placed in the area 51. The table 5 includes an area 52 in which the registered item 92 of a transaction is placed. Although one registered item 92 is shown in FIG. 2, a plurality of registered items 92 may be placed in the area 52. The area 52 is also an area where a basket 7 is placed. The basket 7 is a basket for storing the registered item 92 of one transaction. Note that the area 52 may be an area visible by the store clerk UA (e.g., in front of the store clerk UA) operating the registration device 2-1. Although one basket 7 is shown in FIG. 2, a plurality of baskets 7 may be used in the payment of one transaction.

In the example of FIG. 2, two payment devices 3-1 and 3-2 can process the checkout of one transaction based on the item registration in the registration device 2-1 among the plurality of payment devices 3. The number of payment devices 3 capable of processing the payment of one transaction based on the item registration in the registration device 2-1 may be one or three or more.

The customer UB can place a part or all of the registered items 92 of one transaction on a table 8-1 in order to pay for one transaction using the payment device 3-1. On the table 8-1, the basket 7 containing some or all of the registered items 92 of one transaction of the customer UB can be placed. the customer UB can place a part or all of the registered items 92 of one transaction on a table 8-2 in order to pay for one transaction using the payment device 3-2. On the table 8-2, the basket 7 containing some or all of the registered items 92 of one transaction of the customer UB.

The sensor 4-1 is connected to the payment device 3-1. The sensor 4-1 may be installed on the back of the payment device 3-1 so that the store clerk UA is detected by the sensor 4-1 with a simple movement of the hand or the like. The sensor 4-2 is connected to the payment device 3-2. The sensor 4-2 may be installed on the back of the payment device 3-2 so that the store clerk UA is detected by the sensor 4-2 with a simple movement of the hand or the like. The recognition range of the sensor 4-1 and the recognition range of the sensor 4-2 preferably do not overlap each other. It should be noted that three or more payment devices 3 capable of processing the payment of one transaction based on the item registration in the one registration device 2-1 may be provided.

The store clerk UA performs a motion for the sensor 4-1 to detect the store clerk UA when the customer UB wants the payment device 3-1 to perform the checkout of one transaction based on the item registration in the registration device 2-1. For example, the store clerk UA enters the recognition area of the sensor 4-1 by moving his/her hand closer to the sensor 4-1 or the like. The store clerk UA performs a motion for the sensor 4-2 to detect the store clerk UA when the customer UB wants the payment device 3-2 to perform the checkout of one transaction based on the item registration in the registration device 2-1. For example, the store clerk UA enters the recognition area of the sensor 4-2 by moving the hand closer to the sensor 4-2 or the like.

As described with reference to FIG. 2, in the data processing system S, one registration device 2, a plurality of payment devices 3, and a plurality of sensors 4 associated with each other constitute a group. The data processing system S includes a number of groups according to the number of registration devices 2.

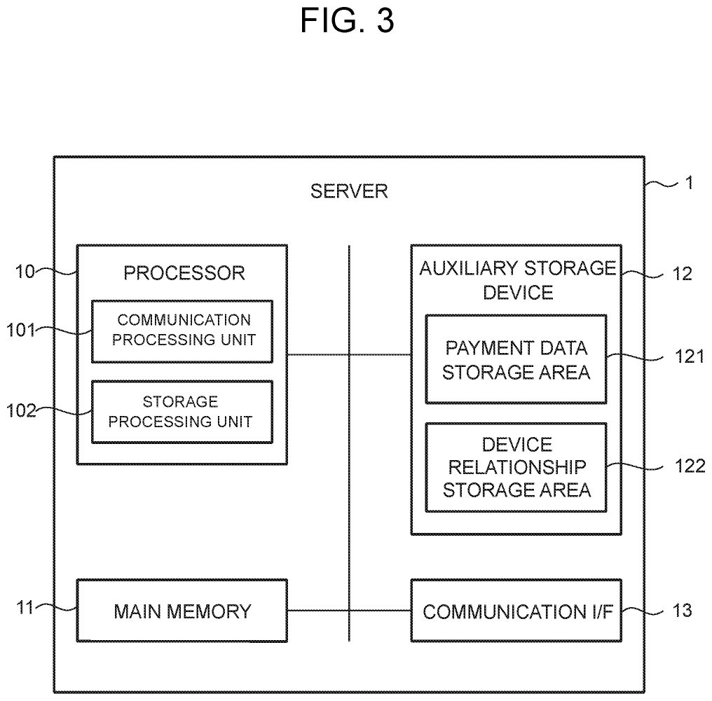

A configuration example of the server 1 will be described. FIG. 3 is a hardware block diagram of the server 1. The server 1 includes a processor 10, a main memory 11, an auxiliary storage device 12, and a communication interface (I/F) 13. The respective units constituting the server 1 are connected to each other so as to be able to input and output signals.

The processor 10 is, but not limited to, a central processing unit (CPU). The processor 10 may be configured by various circuits. The processor 10 loads a program stored in advance in the auxiliary storage device 12 onto the main memory 11. The program causes the processor 10 to perform the function of each unit to be described later. The processor 10 performs various functions by executing the program loaded onto the main memory 11.

The main memory 11 includes a nonvolatile memory area and a volatile memory area. The non-volatile memory area of the main memory 11 stores an operating system and/or programs. The volatile memory area of the main memory 11 is used as a work area in which data is rewritten by the processor 10. For example, the main memory 11 includes a read only memory (ROM) as the non-volatile memory area. For example, the main memory 11 includes a random access memory (RAM) as the volatile memory area.

The auxiliary storage device 12 is an electric erasable programmable read-only memory (EEPROM (registered trademark), a hard disc drive (HDD), or a solid state drive (SSD), or the like. The auxiliary storage device 12 stores the above-described programs, data used by the processor 10 in performing various types of processing, and data generated by the processor 10.

The auxiliary storage device 12 may include a payment data storage area 121. The payment data storage area 121 may store a second payment data for each registration device 2. The second payment data may be any data that can be processed by the payment device 3 to complete the payment transaction, and the format of the second payment data is not limited. The second payment data is generated based on the item registration in the registration device 2. Therefore, the second payment data is based on the first payment data acquired or received from the registration device 2 by the server 1. The second payment data is associated with information indicating the registration device 2 that generated the first payment data.

In one example, the second payment data is the same data as the first payment data generated by the registration device 2. In this example, the first payment data and the second payment data may be transaction data.

In another example, the second payment data is generated based on the first payment data. In this example, the first payment data may be transaction data, and the second payment data may be data indicating a code that uniquely indicates the transaction. The data of the code is associated with the transaction data. The server 1 generates the data of the code based on the transaction data acquired from the registration device 2.

The auxiliary storage device 12 may include a device relationship storage area 122. The device relationship storage area 122 may store device relationship data. The device relationship data is data in which, for each registration device 2, one registration device 2 and a plurality of payment devices 3 capable of processing the payment of one transaction based on the item registration in the registration device 2 are associated with each other.

The device relationship data will be described with reference to an example of the registration device 2-1, the payment device 3-1, and the payment device 3-2 illustrated in FIG. 2. The device relationship data includes data in which one registration device 2-1 and two payment devices 3-1 and 3-2 capable of processing the payment of one transaction based on the item registration in the registration device 2-1 are associated with each other.

The communication interface 13 includes various interface circuits for communicably connecting the server 1 to other electronic devices via a network NW in accordance with a predetermined communication protocol.

The hardware configuration of the server 1 is not limited to the above-described configuration. One or more of the above-described components of the server 1 may be omitted or modified, and one or more new components may be added thereto as appropriate.

Each function performed by the processor 10 will be described. The processor 10 operates as a communication processing unit 101 and a storage processing unit 102 by executing the control program loaded onto the main memory 11.

The communication processing unit 101 processes communication between the server 1 and other electronic devices via the communication interface 13. The communication processing unit 101 acquires data, information, or signals from other electronic devices via the communication interface 13. The communication processing unit 101 controls the communication interface 13 to output or transmit data, information, or signals to other electronic devices.

The storage processing unit 102 stores data or information in the auxiliary storage device 12. The storage processing unit 102 may store data or information in the main memory 11.

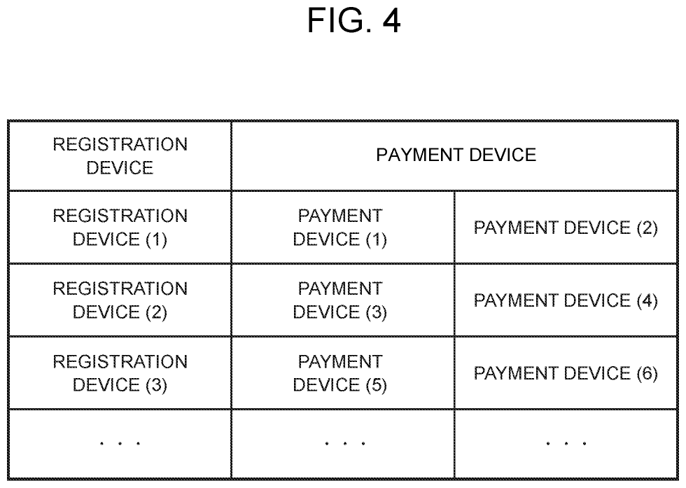

The device relationship data will be described with reference to FIG. 4. FIG. 4 depicts an example of the data structure of the device relationship data stored in the server 1. As shown in the figure, The registration devices (1), (2), and (3) are associated with two payment devices (1) and (2), (3) and (4), and (5) and (6), respectively.

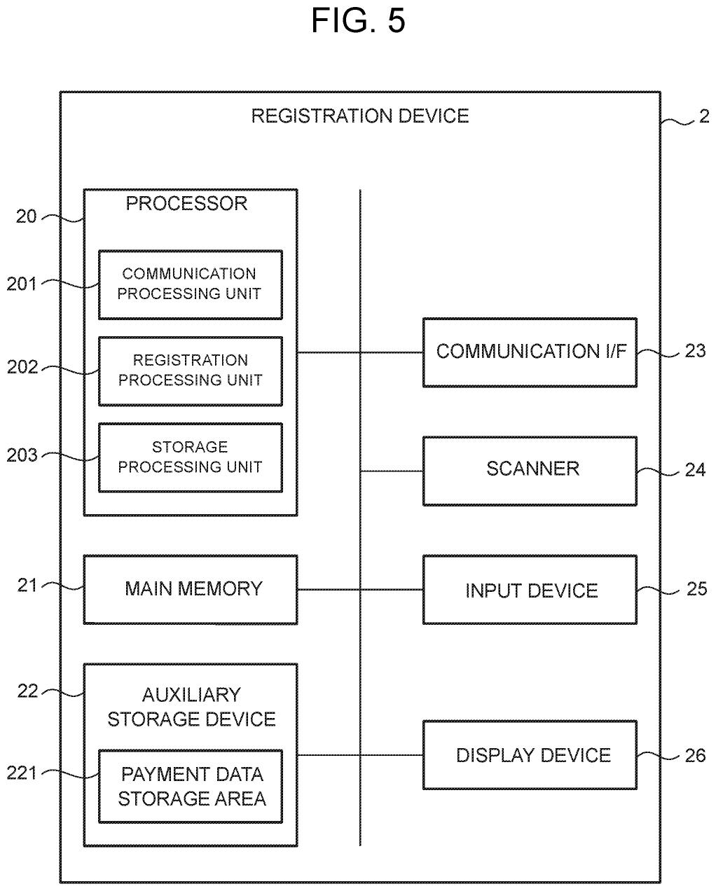

A configuration example of the registration device 2 will be described. FIG. 5 is a hardware block diagram of the registration device 2. The registration device 2 is an electronic device including a processor 20, a main memory 21, an auxiliary storage device 22, a communication interface (I/F) 23, a scanner 24, an input device 25, and a display device 26. The processor 20, the main memory 21, the auxiliary storage device 22, the communication interface 23, the scanner 24, the input device 25, and the display device 26 are connected to each other so that signals can be input and output.

The processor 20 may have a hardware configuration similar to that of the processor 10 described above. The processor 20 is a processing circuit of the registration device 2. The processor 20 loads a program stored in advance in the auxiliary storage device 22 onto the main memory 21. The program causes the processor 20 to perform the function of each unit to be described later. The processor 20 performs various functions by executing the program loaded onto the main memory 21.

The main memory 21 may have a hardware configuration similar to that of the main memory 11 described above.

The auxiliary storage device 22 may have a hardware configuration similar to that of the auxiliary storage device 12 described above. The auxiliary storage device 22 stores the above-described programs, data used by the processor 20 in performing various types of processing, and data generated by the processor 20.

The auxiliary storage device 22 may include a payment data storage area 221. The payment data storage area 221 can store the first payment data based on the item registration of one transaction in the registration device 2. The payment data storage area 121 may store output destination information for the first payment data. The first payment data and the output destination information are associated with each other.

The communication interface 23 includes various interface circuits for communicatively connecting the registration device 2 to other electronic devices via the network NW in accordance with a predetermined communication protocol.

The scanner 24 is an imaging device that reads various code symbols and acquires data from the code symbols. The scanner 24 may include a scanner using an image sensor such as a charge-coupled device (CCD), or may include a laser-type scanner. For example, the code symbol may be a barcode symbol or a two-dimensional code symbol. The code symbol may include a code symbol of an item in which a code capable of identifying the item is recorded. The code symbol of the item is an image attached to the item. The code symbol may include a code symbol in which a member or customer code of the store is recorded. The code symbol of the member may be an image shown on the card issued for the member or an image displayable on the customer's terminal.

The input device 25 is a device capable of receiving an input of an instruction to the registration device 2. For example, the input device 25 may include a keyboard. The input device 25 may include a touch screen configured with the display device 26.

The display device 26 is a device capable of displaying various images under the control of the processor 20. For example, the display device 26 may be a liquid crystal display or an Electroluminescence (EL) display.

Note that the hardware configuration of the registration device 2 is not limited to the above-described configuration. One or more of the above-described components of the registration device 1 may be omitted or modified, and one or more new components may be added thereto as appropriate.

Each function performed by the processor 20 will be described. The processor 20 operates as a communication processing unit 201, a registration processing unit 202, and a storage processing unit 203 by executing the program loaded onto the main memory 21.

The communication processing unit 201 processes communication between the registration device 2 and other electronic devices via the communication interface 23. The communication processing unit 201 acquires data, information, or signals from other electronic devices via the communication interface 23. The communication processing unit 201 controls the communication interface 23 to output or transmit data, information, or a signal to another electronic device.

The registration processing unit 202 registers the item based on the item registration operation of each item of one transaction using the scanner 24 or the input device 25 by the store clerk.

The storage processing unit 203 stores data or information in the auxiliary storage device 22. The storage processing unit 203 may store data or information in the main memory 21.

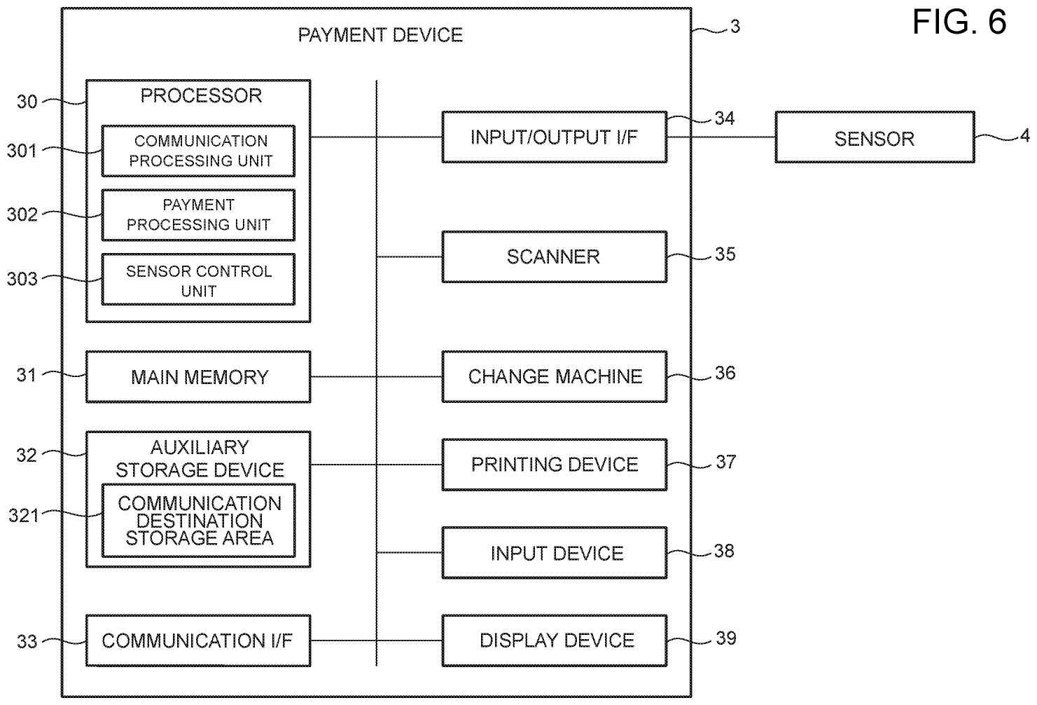

A configuration example of the payment device 3 will be described. FIG. 6 is a hardware block diagram of the payment device 3. The payment device 3 is an electronic device including a processor 30, a main memory 31, an auxiliary storage device 32, a communication interface (I/F) 33, an input/output interface 34, a scanner 35, a change machine 36, a printing device 37, an input device 38, and a display device 39. The processor 30, the main memory 31, the auxiliary storage device 32, the communication interface 33, the input/output interface 34, the scanner 35, the change machine 36, the printing device 37, the input device 38, and the display device 39 are connected to each other so that signals can be input and output.

The processor 30 may have a hardware configuration similar to that of the processor 10 described above. The processor 30 is a processing circuit of the payment device 3. The processor 30 loads a program stored in advance in the auxiliary storage device 32 onto the main memory 31. The program causes the processor 30 to perform the function of each unit to be described later. The processor 30 performs various functions by executing the program loaded onto the main memory 31.

The main memory 31 may have a hardware configuration similar to that of the main memory 11 described above.

The auxiliary storage device 32 may have a hardware configuration similar to that of the auxiliary storage device 12 described above. The auxiliary storage device 32 stores the above-described programs, data used by the processor 30 in performing various types of processing, and data generated by the processor 30.

The auxiliary storage device 32 may include a communication destination storage area 321. The communication destination storage area 321 can store communication destination information. The communication destination information is information indicating an electronic device with which the payment device 3 communicates. The communication destination information includes information indicating the registration device 2 with which the payment device 3 communicates among the plurality of registration devices 2 included in the data processing system S.

The communication destination information will be described with reference to an example of the registration device 2-1, the payment device 3-1, and the payment device 3-2 illustrated in FIG. 2. The communication destination information stored in the payment device 3-1 includes information indicating the registration device 2-1 communicated by the payment device 3-1 among the plurality of registration devices 2 included in the data processing system S. The communication destination information stored in the payment device 3-2 includes information indicating the registration device 2-1 with which the payment device 3-2 communicates among the plurality of registration devices 2 included in the data processing system S.

The communication interface 33 includes various interface circuits that communicatively connect the payment device 3 to other electronic devices via the network NW in accordance with a predetermined communication protocol.

The input/output interface 34 includes various interface circuits that are communicably connected to the payment device 3 by directly wired or wireless connection with other electronic devices. For example, the input/output interface 34 connects the payment device 3 to a card reader. The card reader is a device that reads card data recorded on a magnetic stripe or Integrated Circuit (IC) chip of a card medium. The card medium may include a credit card. For example, the input/output interface 34 connects the payment device 3 to the sensor 4.

The scanner 35 is an imaging device that reads various code symbols and acquires data from the code symbols. The scanner 35 may have a hardware configuration similar to that of the scanner 24 described above. For example, the code symbol may include a code symbol for code payment.

The change machine 36 is a device that pays out bills or coins corresponding to the change amount.

The printing device 37 is a printer for printing on a receipt. For example, the printing device 37 is a thermal printer, an inkjet printer, or the like.

The input device 38 is a device capable of receiving an input of an instruction to the payment device 3. The input device 38 may have a hardware configuration similar to that of the input device 25 described above.

The display device 39 is a device capable of displaying various images under the control of the processor 30. The display device 39 may have a hardware configuration similar to that of the display device 26 described above.

Note that the hardware configuration of the payment device 3 is not limited to the above-described configuration. One or more of the above-described components of the payment device 1 may be omitted or modified, and one or more new components may be added thereto as appropriate.

Each function performed by the processor 30 will be described. The processor 30 operates as a communication processing unit 301, a payment processing unit 302, and a sensor control unit 303 by executing the program loaded onto the main memory 31.

The communication processing unit 301 processes communication between the payment device 3 and other electronic devices via the communication interface 33. The communication processing unit 301 acquires data, information, or signals from other electronic devices via the communication interface 33. The communication processing unit 301 controls the communication interface 33 to output or transmit data, information, or signals to other electronic devices.

The payment processing unit 302 processes the payment of one transaction based on the payment data. The payment processing unit 302 processes the payment of one transaction according to the selection of the payment method by the customer. The payment method includes offline payment and online payment. In the offline payment, the payment device 3 does not require cooperation with other electronic devices via a network such as the Internet. For example, the offline payment is cash payment. The online payment is executed by the payment device 3 in cooperation with other electronic devices via a network such as the Internet. For example, the online payment is a payment by credit card, electronic money, debit card, and barcode.

The sensor control unit 303 controls the sensor 4 connected to the payment device 3. For example, the sensor control unit 303 controls the sensor 4 to be in an enabled state or a disabled state. Controlling the sensor 4 to the enabled state includes changing the sensor 4 from the disabled state to the enabled state. Controlling the sensor 4 to the enabled state includes maintaining the sensor 4 in the enabled state. Controlling the sensor 4 to the disabled state includes changing the sensor 4 from the enabled state to the disabled state. Controlling the sensor 4 to the disabled state includes maintaining the sensor 4 in the disabled state. The enabled state is a state in which the detection function of the sensor 4 is enabled. In the enabled state, the detecting function of the sensor 4 is ON, and the sensor 4 detects a person present in the recognition range of the sensor 4. In the disabled state, the detection function of the sensor 4 is disabled. In the disabled state, the detecting function of the sensor 4 is OFF, and the sensor 4 does not detect a person present in the recognition range of the sensor 4.

### Operation Example

Operation examples of the data processing system S configured as described above will be described. Here, the server 1, the registration device 2-1, the payment device 3-1, and the payment device 3-2 illustrated in FIG. 2 will be described as an example. The process described below is merely an example, and each step may be changed. Further, steps can be omitted, replaced, and added as appropriate according to the embodiment with respect to the processing procedure described below.

### First Operation Example

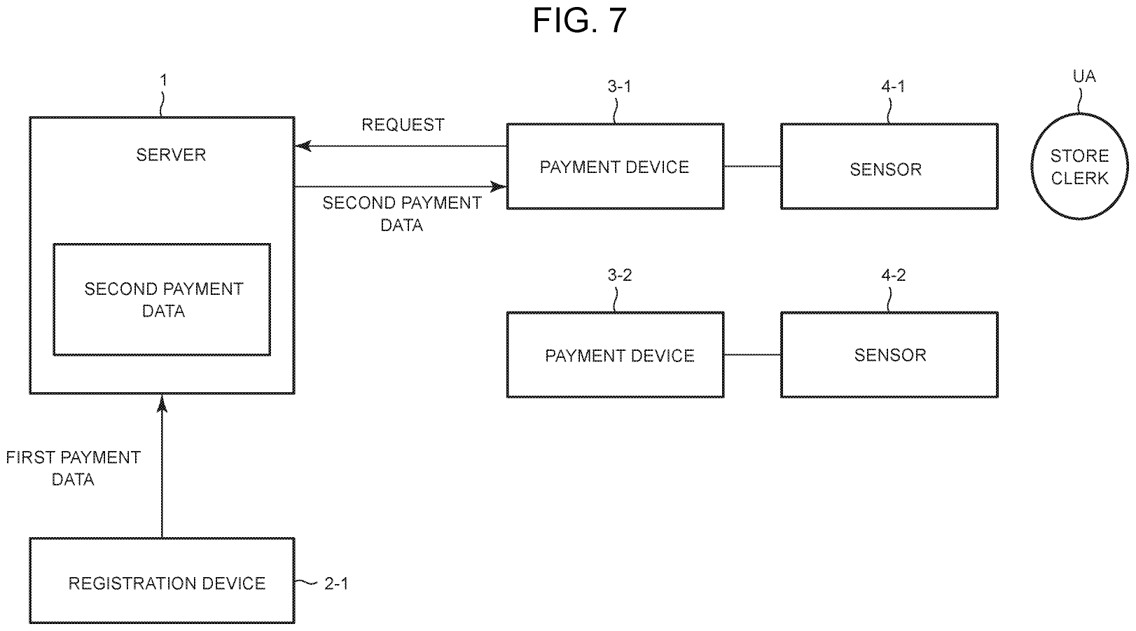

A first operation example will be described. In the first operation example, the server 1 stores payment data. FIG. 7 is a diagram illustrating a first operation example of the data processing system S.

The registration device 2-1 generates first payment data based on the item registration of one transaction of the customer UB. The registration device 2-1 outputs the first payment data to the server 1.

The server 1 acquires the first payment data from the registration device 2-1. The server 1 stores the second payment data based on the first payment data in the auxiliary storage device 12.

It is assumed that the store clerk UA enters the recognition area of the sensor 4-1 connected to the payment device 3-1, and the sensor 4-1 detects the store clerk UA. The payment device 3-1 outputs a request for payment data to the server 1 based on the detection of the store clerk UA by the sensor 4-1. The request may be any command or signal requesting payment data. Since the sensor 4-2 does not detect the store clerk UA, the payment device 3-2 does not output any request to the server 1.

The server 1 outputs the second payment data to the payment device 3-1 in response to the request from the payment device 3-1. In this case, since the server 1 has not acquired any request from the payment device 3-2, it does not output the second payment data to the payment device 3-2.

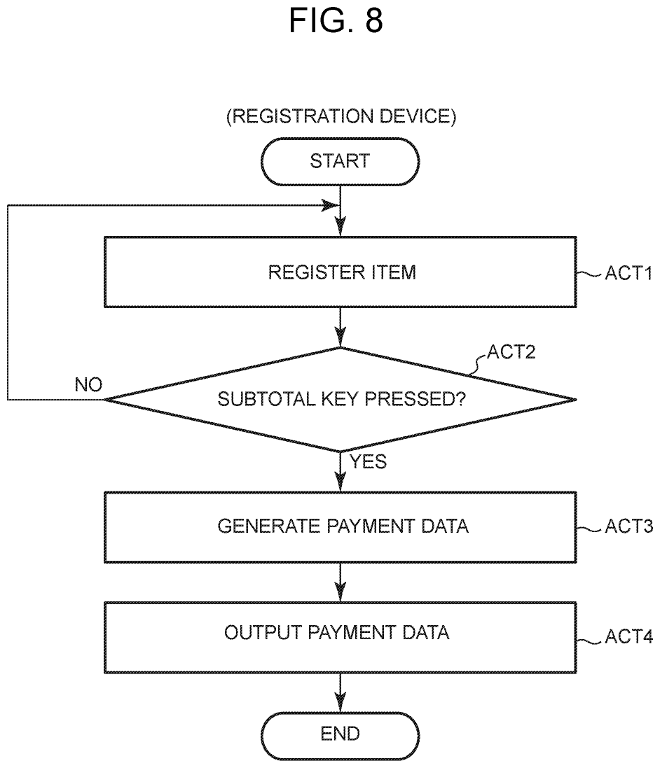

The processing performed by the registration device 2-1 in the first operation example will be described. FIG. 8 is a flowchart of processing performed by the processor 20 of the registration device 2-1 in the first operation example.

The registration processing unit 202 registers an item based on the item registration operation in a single transaction using the scanner 24 or the input device 25 by the store clerk UA (ACT1). In ACT1, for example, the registration processing unit 202 acquires the item data from the auxiliary storage device 22 or the server 1 based on the code of the item input using the scanner 24 or the input device 25. The registration processing unit 202 registers the product data in the main memory 21 or the auxiliary storage device 22.

The registration processing unit 202 detects that the subtotal key has been pressed by the store clerk UA using the input device 25 (ACT2). The subtotal key is for inputting the instruction regarding the end of the item registration of one transaction in order to calculate the payment amount of one transaction. When the subtotal key is not pressed in the registration device 2-1 (ACT2, NO), the registration processing unit 202 continues the processing of ACT1. When the subtotal key is pressed in the registration device 2-1 (ACT2, YES), the process transitions from ACT2 to ACT3.

When the subtotal key is pressed in the registration device 2-1, the registration processing unit 202 generates first payment data based on the item registration of one transaction of the customer UB (ACT3). In ACT3, for example, the registration processing unit 202 generates the first payment data based on the item data of each registered item 92 of one transaction.

When the subtotal key is pressed in the registration device 2-1, the communication processing unit 201 controls the communication interface 23 to output the first payment data to the server 1 (ACT4).

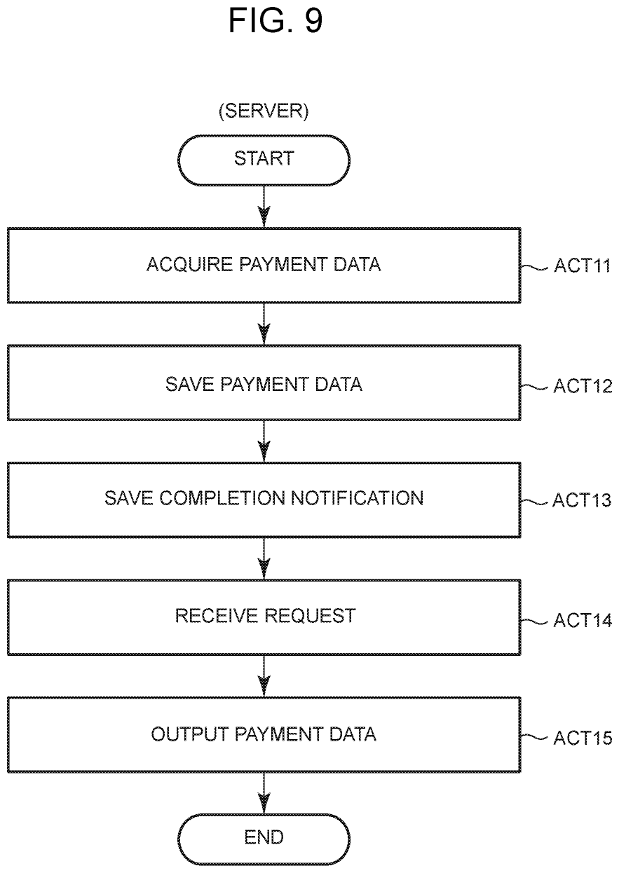

Processing by the server 1 in the first operation example will be described. FIG. 9 is a flowchart of processing performed by the processor 10 of the server 1 in the first operation example.

The communication processing unit 101 acquires the first payment data from the registration device 2-1 (ACT11).

The storage processing unit 102 saves second payment data in the auxiliary storage device 12 (ACT12). In ACT12, for example, the storage processing unit 102 stores the second payment data in the auxiliary storage device 12 based on the first payment data. The storage processing unit 102 may store the second payment data, which is the same data as the first payment data, in the auxiliary storage device 12. The storage processing unit 102 may store the second payment data generated based on the first payment data in the auxiliary storage device 12.

As described above, when the subtotal key is pressed in the registration device 2-1, the registration device 2-1 outputs the first payment data to the server 1. The storage processing unit 102 saves the second payment data in the auxiliary storage device 12 based on the first payment data by the communication processing unit 101. Therefore, when the subtotal key is pressed in the registration device 2-1, the storage processing unit 102 saves the second payment data in the auxiliary storage device 12. The storage processing unit 102 may store the second payment data in the main memory 11.

When the second payment data is stored in the auxiliary storage device 12 by the storage processing unit 102, the communication processing unit 101 controls the communication interface 13 to output a save completion notification to the payment device 3-1 and the payment device 3-2 (ACT13). The save completion notification is a notification related to the save completion of the payment data. Thus, the save completion notification is issued after the subtotal key is pressed in the registration device 2-1. The save completion notification from the server 1 is a notification regarding the save completion of the second payment data to the auxiliary storage device 12 of the server 1. For example, the save completion notification from the server 1 is a notification indicating that the second payment data is stored in the auxiliary storage device 12 in the server 1. The notification may be issued as any type of signal or command.

The communication processing unit 101 acquires a request from the payment device 3-1 or the payment device 3-2 (ACT14). Here, it is assumed that the communication processing unit 101 acquires the request from the payment device 3-1.

The communication processing unit 101 controls the communication interface 13 to output the second payment data to the payment device 3-1 (ACT15). In ACT15, for example, the communication processing unit 101 controls the communication interface to output the second payment data to the payment device 3-1 in response to the request from the payment device 3-1. The processor 10 can identify the registration device 2-1 associated with the payment device 3-1 that is the source of the request based on the device relationship data stored in the auxiliary storage device 12. The processor 10 may acquire the second payment data associated with the information indicating the identified registration device 2-1 among the second payment data stored in the auxiliary storage device 12.

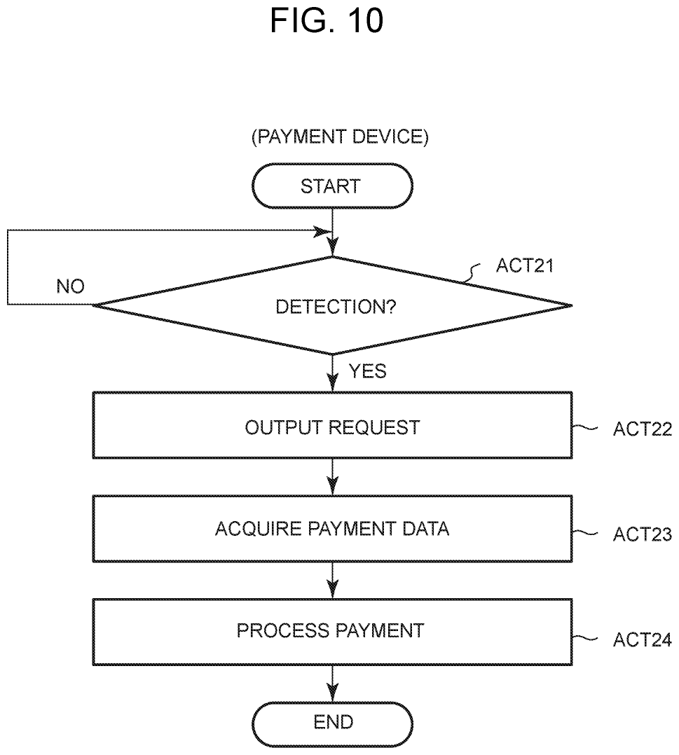

The processing by the payment device 3-1 in the first operation example will be described. First, a process related to the acquisition of the payment data by the payment device 3-1 in the first operation example will be described. FIG. 10 is a flowchart of a process related to the acquisition of payment data by the processor 30 of the payment device 3-1 in the first operation example.

The sensor control unit 303 determines whether the store clerk UA has been detected by the sensor 4-1 (ACT21). In ACT21, for example, the sensor control unit 303 may determine that the store clerk UA has been detected by the sensor 4-1 on the basis of a signal indicating detection of the store clerk UA from the sensor 4-1. If the sensor control unit 303 does not determine that the store clerk UA has been detected by the sensor 4-1 (ACT21, NO), ACT21 process is repeated. When the sensor control unit 303 determines that the store clerk UA has been detected by the sensor 4-1 (ACT21, YES), the process transitions from ACT21 to ACT22.

The communication processing unit 301 controls the communication interface 33 to output the request to the server 1 in response to on the detection of the store clerk UA by the sensor 4-1 (ACT22).

The communication processing unit 301 acquires the second payment data from the server 1 after the detection of the store clerk UA by the sensor 4-1 (ACT23). In ACT23, for example, the communication processing unit 301 acquires the second payment data from the server 1 as a response to the request.

The payment processing unit 302 processes the payment of one transaction based on the second payment data (ACT24). In ACT24, for example, the payment processing unit 302 processes the payment of one transaction based on the second payment data in accordance with the payment methods selected by the customer UB using the input device 38. When the second payment data is data of a code that uniquely indicates a transaction, the communication processing unit 301 acquires data required for payment from the server 1 via the network NW based on the second payment data.

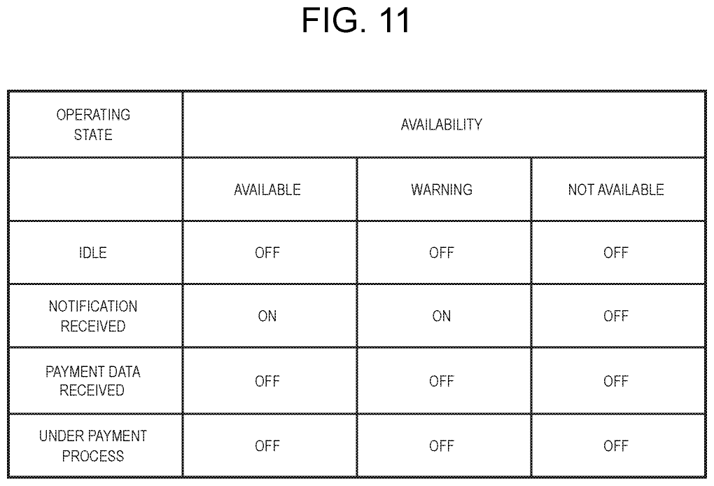

Next, the processing about control of the sensor 4-1 by the payment device 3-1 in a first example of operation will be described. FIG. 11 is a diagram illustrating control of the sensor 4-1 by the processor 30 of the payment device 3-1 in the first operation example. “ON” in FIG. 11 indicates the enabled state of the sensor 4-1, and “OFF” in FIG. 11 indicates the disabled state.

The operating state of the payment device 3-1 is a state related to the operation of the payment device 3-1. For example, the operating state of the payment device 3-1 includes a plurality of states such as “idle”, “notification received”, “payment data received”, and “under payment process”. For example, the operating state of the payment device 3-1 transitions in the order of the “idle” state, the “notification received” state, the “payment data received” state, and the “under payment process” state. The operating state of the payment device 3-1 transitions from the “under payment process” state to the “idle” state after the “under payment process” state.

In the “idle” state, the payment processing of one transaction by the payment processing unit 302 is waiting to be started. For example, the “idle” state is a period after the completion of the payment process of one previous transaction by the payment processing unit 302 to before the start of the payment process of the next transaction by the payment processing unit 302. The payment process of a transaction starts after the second payment data is acquired by the payment device 3-1. The start of the payment process of one transaction may be after the acquisition of the second payment data by the payment device 3-1 and after the display of the information on one transaction such as the billing amount of one transaction on the display device 26. The end of the payment process for one transaction is after the end of the payment by the customer UB. The end of the payment process for one transaction may be the timing of discharge of the receipt in the payment device 3-1. The waiting state for the start of the payment processing is an example of a state different from the payment processing state described later.

In the “notification received” state, the communication processing unit 301 has acquired a notification from the server 1 or the registration device 2-1. For example, in the “notification received” state, the communication processing unit 301 has acquired the save completion notification from the server 1.

The “notification received” state may be a state in which a registration end notification from the registration device 2-1 has been acquired by the communication processing unit 301. The registration end notification is a notification indicating the end of the item registration of one transaction in the registration device 2-1. For example, the registration end notification is a notification indicating that the subtotal key is pressed in the registration device 2-1. The registration end notification is issued after the subtotal key is pressed in the registration device 2-1. When the subtotal key is pressed in the registration device 2-1, the communication processing unit 201 controls the communication interface 23 to output the registration end notification to the payment device 3-1 and the payment device 3-2.

The “payment data received” state is a state in which the communication processing unit 301 has acquired the second payment data in the idle state.

The “under payment process” state is a state during which a payment process for one transaction is being performed by the payment processing unit 302. For example, the payment processing state is a period from the start of the payment processing of one transaction by the payment processing unit 302 to the end of the payment processing of one transaction.

The availability of the payment device 3-1 indicates whether the payment device 3-1 can be used for payment of a transaction. For example, the availability of the payment device 3-1 indicates a plurality of states such as “available”, “warning”, and “not available”.

The “available” state is a state in which the payment device 3-1 can be used without any attention by the store clerk UA.

The “warning” state requires more attention than the “available” state, but is a state in which the payment device 3-1 can be used. For example, the “warning” state is a state such as a change-nearly-empty state or a receipt-nearly-empty state. Therefore, if the payment device 3-1 continues to be used without performing a maintenance work such as bills and coins replenishment for change or receipt paper replacement, the availability of the payment device 3-1 eventually transitions from the “warning” to “not available”. The availability of the payment device 3-1 may include a multi-level “warning” state. For example, the multiple levels are two levels. The availability of the payment device 3-1 may include a first level “warning” state and a second level “warning” state. The first level “warning” state is a “warning” state that is closer to the “available” state than the “not available” state. The first level “warning” state may be a state in which bills and coins stored in the change machine 36 is nearly empty or receipt paper remaining in the printing device 37 is nearly empty, etc., but the remaining amount has not fallen below a predetermined threshold. The predetermined threshold can be set as appropriate. The second level “warning” state is a “warning” state that is closer to the “not available” state than the “available” state. The second level “warning” state may be a state in which the remaining amount has fallen below the predetermined threshold and is close to empty. The “warning” state in FIG. 11 refers to the first level “warning” state.

The “not available” state is a state in which the payment device 3-1 is not available. For example, the “not available” state is a state in which an error affecting the use of the payment device 3-1, such as out of bills and coins for change, out of paper, a printer jam, or change left behind, is occurring.

With reference to FIG. 11, the control of the sensor 4-1 based on the operating state of the payment device 3-1 will be described. The sensor control unit 303 controls the sensor 4-1 to be in the enabled state or the disabled state depending on the operating state and availability of the payment device 3-1. A case where the availability is “available” will be described as an example, but the same applies to a case where the availability is “warning” state of the first level.

In the “idle” state, the sensor control unit 303 controls the sensor 4-1 to be in the disabled state. The sensor control unit 303 controls the sensor 4-1 to be in the disabled state until a notification is acquired by the communication processing unit 301 in the waiting state for the start of the payment process. For example, the sensor control unit 303 maintains the disabled state until the notification is acquired.

In the “notification received” state, the sensor control unit 303 controls the sensor 4-1 to be in the enabled state. The sensor control unit 303 controls the sensor 4-1 to be in the enabled state in response to the acquisition of the notification by the communication processing unit 301 in the waiting state for the start of the payment process. For example, the sensor control unit 303 changes the state from the disabled state to the enabled state in response to the acquisition of the notification.

The sensor control unit 303 controls the sensor 4-1 to be in the enabled state from the receipt of the notification by the communication processing unit 301 to the receipt of the second payment data by the communication processing unit 301. For example, the sensor control unit 303 maintains the enabled state during that period.

In the “payment data received” state, the sensor control unit 303 controls the sensor 4-1 to be in the disabled state. The sensor control unit 303 controls the sensor 4-1 to be in the disabled state in response to the acquisition of the second payment data by the communication processing unit 301. The sensor control unit 303 controls the sensor 4-1 to be in the disabled state in response to the acquisition of the second payment data after the acquisition of the notification by the communication processing unit 301 in the waiting state for the start of the payment processing. For example, the sensor control unit 303 changes the state from the enabled state to the disables state in response to the acquisition of the second payment data.

In the “under payment process” state, the sensor control unit 303 controls the sensor 4-1 to be in the disabled state. The sensor control unit 303 controls the sensor 4-1 to be in the disabled state in the payment processing state of one transaction by the payment processing unit 302. For example, the sensor control unit 303 maintains the disabled state during the payment process. The sensor control unit 303 controls the sensor 4-1 to be in the disabled state based on the acquisition of the notification by the communication processing unit 301 in the payment processing state of one transaction by the payment processing unit 302. For example, the sensor control unit 303 maintains the disabled state after the acquisition of the notification. As a result, the payment device 3-1 can prevent the sensor 4-1 connected to the payment device 3-1 during the checkout process from detecting the store clerk UA. Since the sensor 4-1 does not detect the store clerk UA, the payment device 3-1 does not acquire new second payment data during the checkout process.

When the availability is “not available”, the sensor control unit 303 controls the sensor 4-1 to be in the disabled state regardless of the operating state of the payment device 3-1. For example, the sensor control unit 303 maintains the sensor 4-1 in a disabled state regardless of the operating state of the payment device 3-1.

Referring to FIG. 11, the control of the sensor 4-1 in accordance with the availability of the payment device 3-1 will be described. The sensor control unit 303 changes the control of the sensor 4-1 based on the operating state of the payment device 3-1 in accordance with the availability of the payment device 3-1. For example, the sensor control unit 303 changes the control of the sensor 4-1 based on the notification acquired by the communication processing unit 301 in the stand-by state for the start of the payment processing in accordance with the availability of the payment device 3-1. When the availability is “available” or “warning” state of the first level, the sensor control unit 303 controls the sensor 4-1 to be in the enabled state in response to the notification acquired by the communication processing unit 301 in the waiting state for starting the checkout processing. When the availability is “not available” or “warning” state of the second level, the sensor control unit 303 controls the sensor 4-1 to be in the disabled state in response to the notification acquired by the communication processing unit 301 in the waiting state for starting the payment processing.

Note that the sensor control unit 303 may not change the control of the sensor 4-1 between the case where the availability is in the “warning” state of the first level and the case where “warning” state of the second level. In this case, whether to change the control of the sensor 4-1 between the case where the availability is in the “warning” state of the first level and the case where the control is in the “warning” state of the second level may be changeable by setting. The settings include a first setting that changes control of the sensor 4-1 when the availability is in the first level “warning” state and when it is in the second level “warning” state. The setting includes a second setting that does not change the control of the sensor 4-1 when the availability is in the “warning” state of the first level and when it is in the “warning” state of the second level. When the setting is the first setting, the sensor control unit 303 changes the control of the sensor 4-1 as described above between the case where the availability is in the “warning” state of the first level and the case where the setting is in the “warning” state of the second level. When the setting is the second setting, the sensor control unit 303 does not change the control of the sensor 4-1 between the case where the availability is in the “warning” state of the first level and the case where the setting is in the “warning” state of the second level. In this embodiment, when the availability is in the “warning” state, the sensor control unit 303 controls the sensor 4-1 in the same manner as when the availability is in the “not available” state.

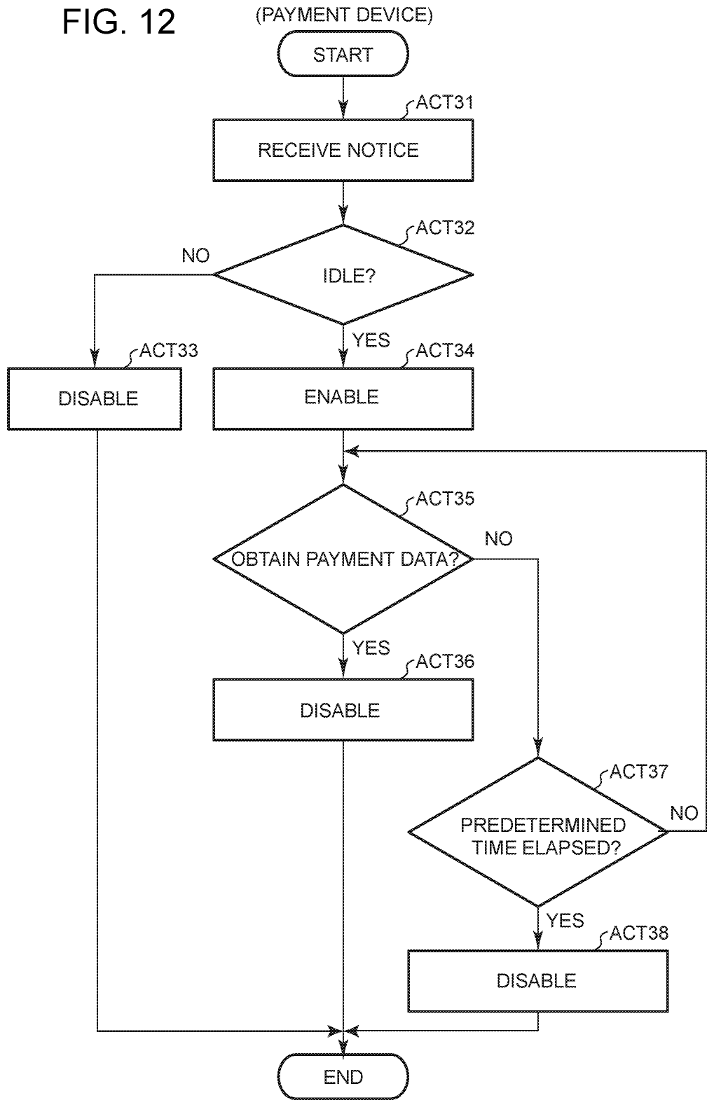

FIG. 12 is a flowchart of a process related to the control of the sensor 4-1 by the processor 30 of the payment device 3-1 in the first operation example.

The communication processing unit 301 acquires a notification (ACT31). For example, the communication processing unit 301 acquires a save completion notification from the server 1. In another example, the communication processing unit 301 acquires a registration end notification from the registration device 2-1.

The sensor control unit 303 determines whether the operating state of the payment device 3-1 is in the “idle” state in response to the notification acquired by the communication processing unit 301 (ACT32). When the operating state of the payment device 3-1 is not “idle” (ACT32, NO), the process transitions from ACT32 to ACT33. When the operating state of the payment device 3-1 is not the “idle” state, it is assumed that the operating state of the payment device 3-1 is the “under payment process” state. When the operating state of the payment device 3-1 is “idle” (ACT32, YES), the process transitions from ACT32 to ACT34.

The sensor control unit 303 controls the sensor 4-1 to be in the disabled state in response to the notification obtained by the communication processing unit 301 in the “under payment process” state (ACT33).

The sensor control unit 303 controls the sensor 4-1 to be in the enabled state in response to the notification obtained by the communication processing unit 301 in the “idle” state (ACT34).

The sensor control unit 303 determines whether the communication processing unit 301 has acquired second payment data (ACT35). When the sensor control unit 303 determines that the second payment data has been acquired by the communication processing unit 301 (ACT35, YES), the processing transitions from ACT35 to ACT36. When the sensor control unit 303 does not determine that the second payment data has been acquired by the communication processing unit 301 (ACT35, NO), the processing transitions from ACT35 to ACT37.

The sensor control unit 303 controls the sensor 4-1 to be disabled in response to the second payment data acquired by the communication processing unit 301 (ACT36).

The sensor control unit 303 determines whether a predetermined period of time has elapsed since the notification was received by the communication processing unit 301 (ACT37). The predetermined time period can be set as appropriate. When the sensor control unit 303 determines that the predetermined period has elapsed (ACT37, YES), the process transitions from ACT37 to ACT38. If the sensor control unit 303 does not determine that the predetermined period has elapsed (ACT37, NO), the process transitions from ACT37 to ACT35.

The sensor control unit 303 controls the sensor 4-1 to be disabled upon elapse of the predetermined time (ACT38).

Note that the processing performed by the payment device 3-2 in the first operation example is the same as the processing performed by the payment device 3-1 in the first operation example, and thus description thereof will be omitted.

In the first operation example, the data processing system S may include a server 1 including at least a communication processing unit 101 and a storage processing unit 102, and a payment device 3-1 including at least a communication processing unit 301 and a payment processing unit 302.

### Second Operation Example

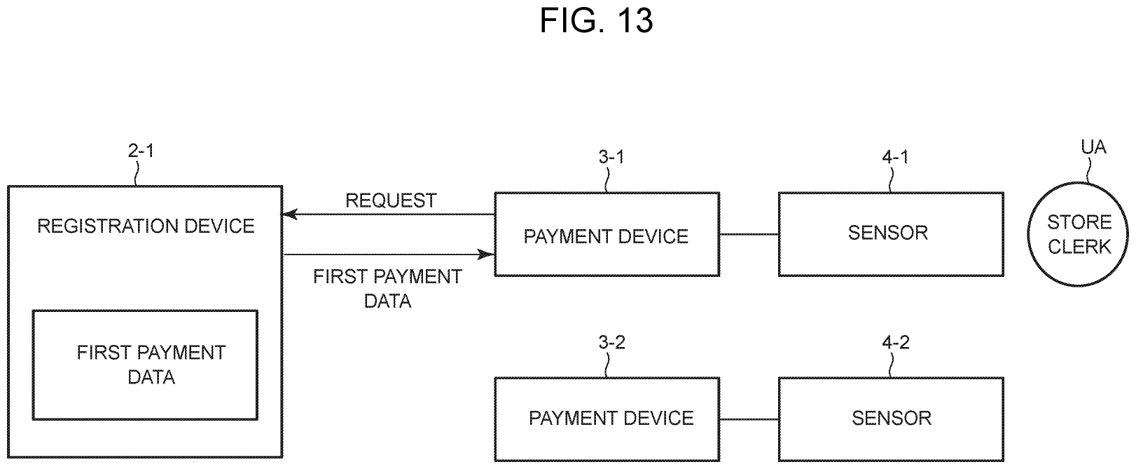

A second operation example will be described. The second operation example is an example in which the registration device 2-1 stores the payment data. FIG. 13 depicts the second operation example of the data processing system S.

The registration device 2-1 generates first payment data based on the item registration of one transaction of the customer UB. The registration device 2-1 stores the first payment data in the auxiliary storage device 22.

It is assumed that the store clerk UA enters the recognition area of the sensor 4-1 connected to the payment device 3-1, and the sensor 4-1 detects the store clerk UA. The payment device 3-1 outputs a request to the registration device 2-1 in response to the detection of the store clerk UA by the sensor 4-1. Since the sensor 4-2 does not detect the store clerk UA, the payment device 3-2 does not transmit the request to the registration device 2-1.

The registration device 2-1 outputs the first payment data to the payment device 3-1 in response to a request from the payment device 3-1. In this case, since the registration device 2-1 has not acquired any request from the payment device 3-2, it does not output the first payment data to the payment device 3-2.

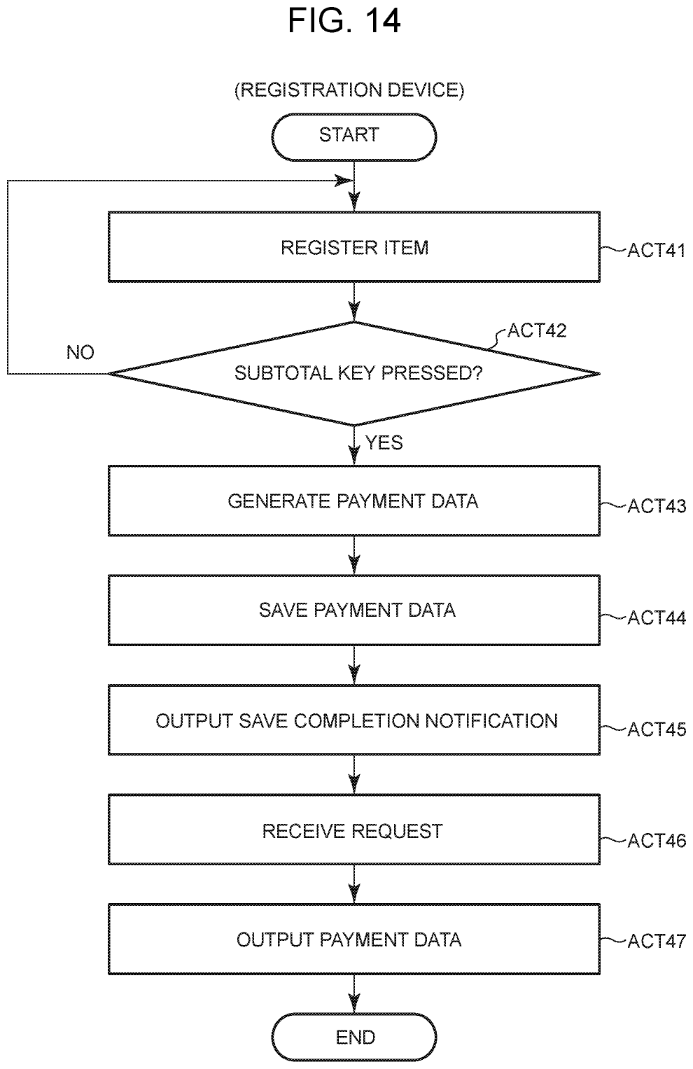

The processing performed by the registration device 2-1 in the second operation example will be described. FIG. 14 is a flowchart of processing by the processor 20 of the registration device 2-1 in the second operation example.

The registration processing unit 202 registers an item based on the item registration operation of the item of one transaction using the scanner 24 or the input device 25 by the store clerk UA (ACT41). ACT41 process is the same as ACT1 process described above.

The registration processing unit 202 detects that the subtotal key has been pressed by the store clerk UA using the input device 25 (ACT42). ACT42 process is the same as ACT2 process described above. When the subtotal key is not pressed in the registration device 2-1 (ACT42, NO), the registration processing unit 202 continues the processing of ACT41. When the subtotal key is pressed in the registration device 2-1 (ACT42, YES), the process transitions from ACT42 to ACT43.

When the subtotal key is pressed in the registration device 2-1, the registration processing unit 202 generates first payment data based on the item registration of one transaction of the customer UB (ACT43). ACT43 process is the same as ACT3 process described above.

When the subtotal key is pressed in the registration device 2-1, the storage processing unit 203 saves the first payment data in the auxiliary storage device 22 (ACT44). The storage processing unit 203 may store the first payment data in the main memory 21.

When the first payment data is stored in the auxiliary storage device 202 by the storage processing unit 203, the communication processing unit 201 controls the communication interface 23 to output a save completion notification to the payment device 3-1 and the payment device 3-2 (ACT45). The save completion notification from the registration device 2-1 is a notification regarding the save completion of the first payment data to the auxiliary storage device 22 of the registration device 2-1. For example, the save completion notification from the registration device 2-1 is a notification indicating that the first payment data is stored in the auxiliary storage device 22 in the registration device 2-1.

The communication processing unit 201 obtains a request from the payment device 3-1 or the payment device 3-2 (ACT46). Here, it is assumed that the communication processing unit 201 acquires a request from the payment device 3-1.

The communication processing unit 201 controls the communication interface 23 to output the first payment data from the registration device 2-1 to the payment device 3-1 (ACT47). In ACT47, for example, the communication processing unit 201 controls the communication interface to output the first payment data to the payment device 3-1 in response to the request from the payment device 3-1.

The processing by the payment device 3-1 in the second operation example will be described.

First, a process related to the acquisition of the payment data by the payment device 3-1 in the second operation example will be described. The processing related to the acquisition of the payment data by the payment device 3-1 in the second operation example is the same as the processing related to the acquisition of the payment data by the payment device 3-1 in the first operation example described with reference to the flowchart illustrated in FIG. 10 except for the following points.

In ACT22 of the first operation example, the communication processing unit 301 controls the communication interface 33 to output the request to the server 1, but the communication processing unit 301 in the second operation examples controls the communication interface 33 to output the request to the registration device 2-1. In the second operation example, the communication processing unit 301 may determine the registration device 2-1 as the registration device 2 with which the payment device 3-1 communicates among the plurality of registration devices 2 based on the communication destination information stored in the auxiliary storage device 32. In ACT23 of the first operation example, the communication processing unit 301 acquires the second payment data from the server 1, but the communication processing unit 301 in the second operation example acquires the first payment data from the registration device 2-1. In ACT24 of the first operation example, the payment processing unit 302 processes the payment of one transaction based on the second payment data, but the payment processing unit 302 in the second operation example process the payment of a transaction based on the first payment data.

Next, the processing about control of the sensor 4-1 by the payment device 3-1 in the second operation example is described.

The processing related to the control of the sensor 4-1 by the payment device 3-1 in the second operation example is the same as the processing related to the control of the sensor 4-1 by the payment device 3-1 in the first operation example described with reference to the flowcharts illustrated in FIGS. 11 and 12 except for the following points.

The above description with respect to FIG. 11 can be applied to the second operation example by replacing “save completion notification from the server 1” with “save completion notification from the registration device 2-1”. The above description with respect to FIG. 11 is applicable to the second operation example by replacing “second payment data” with “first payment data”. In ACT31 of FIG. 12, the communication processing unit 301 acquires the save completion notification from the server 1 in the first operation example, but the communication processing unit 301 in the second operation example acquires the save completion notification from the registration device 2-1. In ACT35 of FIG. 12, the sensor control unit 303 determines whether the second payment data is acquired by the communication processing unit 301 in the first operation example, but the sensor control unit 303 in the second operation example determines whether the first payment data is acquired by the communication processing unit 301. In ACT36 of FIG. 12, the sensor control unit 303 controls the sensor 4-1 to be the disabled state in response to the acquisition of the second payment data by the communication processing unit 301 in the first operation example, but the sensor control unit 303 in the second operation example controls the sensor 4-1 to be the disabled state in response to the acquisition of the first payment data by the communication processing unit 301.

Note that the processing performed by the payment device 3-2 in the second operation example is the same as the processing performed by the payment device 3-1 in the second operation example, and thus description thereof is omitted.

In the second operation example, the data processing system S may include the registration device 2-1 including at least the communication processing unit 201 and the storage processing unit 203, and the payment device 3-1 including at least the communication processing unit 301 and the payment processing unit 302.

### Effect

The payment device 3 according to the above-described embodiments includes a communication processing unit 301 that acquires data related to one transaction based on the item registration in the registration device 2 from the server 1 or the registration device 2 upon detection of the user of the registration device 2 by the sensor 4. The payment device 3 includes a payment processing unit 302 that processes payment of one transaction based on data related to one transaction.

In the payment device 3 according to the embodiments, the communication processing unit 301 controls the communication interface 33 to output a request for data related to one transaction to the server 1 or the registration device 2 in response to the detection by the sensor, and acquires data related to one transaction from the server 1 or the registration device 2 after the output of the request.

Since the payment device 3 acquires the data related to one transaction in response to the detection by the clerk by the sensor 4, the clerk only needs to perform a motion to be detected by the sensor 4 connected to the payment device 3 to be the payment destination. Therefore, the store clerk can omit a predetermined operation required by a conventional registration device for designating a payment device to be used by the customer. Further, since the sensor 4 is connected to the payment device 3 on a one-to-one basis, the store clerk can easily perform the movement as detected by the sensor 4 connected to the payment device 3 to be the checkout destination. As a result, the payment device 3 can reduce the workload on the store clerk operating the registration device 2.

The payment device 3 according to the above-described embodiments includes a sensor control unit 303 that controls the sensor 4 to be in the enabled state or the disabled state based on the operating state of the payment device 3. For example, the sensor control unit 303 controls the sensor 4 to be in the enabled state in response to the acquisition of the notification based on the input of the instruction regarding the end of the item registration of one transaction in the registration device 2 by the communication processing unit 201. The sensor control unit 303 controls the sensor 4 to be in the disabled state based on the acquisition of data related to one transaction by the communication processing unit 301.

As a result, the payment device 3 can control the sensor 4 to be enabled at a timing at which data related to a new transaction can be processed. The payment device 3 may disable the sensor 4 at a timing at which data related to a new transaction cannot be processed, e.g., during a payment process. Therefore, the payment device 3 can prevent the data related to the new transaction from being acquired at a timing at which the data related to the new transaction cannot be processed. In a case where another payment device 3 different from the payment device 3 that the clerk intends to perform checkout cannot process the data related to a new transaction, it is possible to prevent the sensor 4 connected to the other payment device 3 from detecting the clerk.

In the payment device 3 according to the embodiments, the sensor control unit 303 changes the control of the sensor 4 based on the operating state of the payment device 3 in accordance with the availability of the payment device 3.

Thus, for example, the payment device 3 can prevent the sensor 4 to be the enabled state in the event of the “not available” state. The sensor 4 connected to the payment device 3 does not detect a store clerk even if the store clerk accidentally enters the recognition range of the sensor 4. The payment device 3 does not acquire data about a transaction in the “not available” condition. Therefore, the payment device 3 can support smooth payment for the customer.

### Other Embodiments

In the above-described embodiments, the server 1 is illustrated as one electronic device, but the present invention is not limited thereto. The server 1 may be a system in which the functions are distributed among a plurality of electronic devices.

The above-described embodiments may be applied not only to the data processing system S but also to a method executed by the data processing system S. The above-described embodiments may be applied to a program capable of causing a computer to execute processing of each unit included in the data processing system S. The above-described embodiments may be applied not only to an electronic device such as the server 1, the registration device 2, or the payment device 3, but also to a method executed by each electronic device. The above-described embodiments may be applied to a program capable of causing a computer to execute processing of each unit included in each electronic device.

The data processing system S may include one electronic device or may include a plurality of electronic devices. Therefore, each unit included in the data processing system S may be realized by one electronic device or may be realized by being distributed among a plurality of electronic devices.

The program may be transferred in a state stored in the electronic device or may be transferred in a state not stored in the electronic device. In the latter case, the program may be transferred via a network or may be transferred in a state of being recorded on a recording medium. The recording medium is a non-transitory tangible medium. The recording medium is an electronic device readable medium. The recording medium may be any medium that can store programs such as CD-ROM and memory cards and can be read by an electronic device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A payment device to be operated by a customer to make payment for a transaction, wherein transaction data for the transaction is generated by a registration device operated by a store clerk, the payment device comprising:
a sensor configured to detect motion when enabled; and
a processor configured to:
enable the sensor upon receipt of a notification that the transaction data has been generated;
in response to the motion being detected by the sensor while the payment is pending, acquire the transaction data generated by the registration device, and
perform a payment process using the acquired transaction data.

2. The payment device according to claim 1, wherein the processor is configured to issue a request for the transaction data after the motion is detected.

3. The payment device according to claim 1, wherein the processor is configured to disable the sensor based on an operating state of the payment device.

4. The payment device according to claim 3, wherein the processor disables the sensor when the operating state is an idle state.

5. The payment device according to claim 1, wherein the processor disables the sensor upon receipt of the transaction data.

6. The payment device according to claim 1, wherein the processor disables the sensor upon the elapse of a predetermined time after the notification is received.

7. The payment device according to claim 1, wherein the processor disables the sensor based on a remaining amount of bills and coins or receipt paper stored in the payment device.

8. The payment device according to claim 1, wherein the notification is received from the registration device.

9. The payment device according to claim 1, wherein the processor acquires the transaction data from a server connected to the registration device.

10. The payment device according to claim 1, wherein the processor acquires the transaction data directly from the registration device.

11. A point of sale (POS) system comprising:
a registration device that is to be operated by a store clerk and configured to generate transaction data for a customer; and
a payment device that is to be operated by the customer and includes:
a sensor configured to detect motion when enabled, and
a processor configured to:
enable the sensor upon receipt of a notification that the transaction data has been generated,
in response to the motion being detected by the sensor while payment by the customer is pending, acquire the transaction data generated by the registration device, and
perform a payment process using the acquired transaction data.

12. The POS system according to claim 11, wherein the processor is configured to issue a request for the transaction data after the motion is detected.

13. The POS system according to claim 11, wherein the processor is configured to disable the sensor based on an operating state of the payment device.

14. The POS system according to claim 13, wherein the processor disables the sensor when the operating state is an idle state.

15. The POS system according to claim 11, wherein the processor disables the sensor upon receipt of the transaction data.

16. The POS system according to claim 11, wherein the processor disables the sensor upon the elapse of a predetermined time after the notification is received.

17. The POS system according to claim 11, wherein the processor disables the sensor based on a remaining amount of bills and coins or receipt paper stored in the payment device.

18. The POS system according to claim 11, wherein the registration device is configured to transmit the notification to the payment device.

19. The POS system according to claim 11, wherein the processor acquires the transaction data from a server connected to the registration device.

20. A method for performing a payment process using a payment device operated by a customer, the method comprising:
detecting a motion of a store clerk who is operating a registration device to generate transaction data for the customer;
in response to detecting the motion while payment by the customer is pending, acquiring the transaction data; and
performing the payment process using the acquired transaction data.
